(19) United States
(12) Patent Application Publication
(10) Pub. No.: US 2006/0186975 A1
(43) Pub. Date: Aug. 24, 2006

(54) Inductor and method for producing the same

(76) Inventor: Wan-Shiun Wang, Heng-Shan Hsiang (TW)

Correspondence Address: LAW OFFICE OF KENNETH C. BROOKS, P.O. BOX 10417, Austin, TX, 78766-1417, US

(21) Appl. No.: 11/300,736

(22) Filed: Dec. 15, 2005

(30) Foreign Application Priority Data
Feb. 22, 2005 (TW) 094202800

(51) Int. Cl. H01H 51/22

(52) U.S. Cl. 335/83

(57) ABSTRACT

An inductor includes: a core; a coil wound around the core and having two end portions and a coil portion extending between the end portions; and a green compact made from magnetic powder and enclosing the coil portion of the coil and the core in such a manner that the end portions of the coil are exposed from the green compact.

### CROSS-REFERENCE TO RELATED APPLICATION

This application claims priority of Taiwanese application no. 094202800, filed on Feb. 22, 2005.

### BACKGROUND OF THE INVENTION

1. Field of the Invention

This invention relates to an inductor and a method for producing the same, more particularly to an inductor including a core and a coil enclosed in a green compact of magnetic powder and a method for producing the same.

2. Description of the Related Art

In general, the structural design of an inductor depends on the required property, dimensions, and assembly method. As shown in FIG. 1, a conventional inductor generally includes a confining member 10 and a coil 13 surrounded by the confining member 10.

The confining member 10 includes a lower seat 11 and an upper plate 12. The lower seat 11 includes a concave portion 111 with two openings 112 that open at two opposite sides of the lower seat 11, and a rod 110 located at the concave portion 111 of the lower seat 11.

The coil 13 includes a coil portion 131 defining a hole at the center thereof, and two extending portions 132. During assembly, the coil portion 131 is received in the concave portion 111 of the lower seat 11, and is sleeved around the rod 110. The two extending portions 132 of the coil 13 extend outwardly and respectively through the openings 112 in the lower seat 11. Then, the lower seat 11 and the upper plate 12 are bonded by a glue material. The conventional inductor thus formed is shown in FIG. 2.

The process of binding the lower seat 11 and the upper plate 12 using the glue material is complicated and costly. Moreover, as shown in FIG. 2, since a relatively large space is present between the coil portion 131 of the coil 13 and the confining member 10, and since a gap exists between the coil portion 131 of the coil 13 and the rod 110, undesired vibration and noise are generated during activation of the inductor, thereby resulting in core loss and decrease in quality factor (i.e., Q value) of the inductor.

Therefore, there is a need in the art to overcome the aforesaid drawbacks and to further improve quality factor of an inductor.

### SUMMARY OF THE INVENTION

Therefore, the object of the present invention is to provide an inductor with improved quality factor and a method for producing the same.

According to one aspect of this invention, an inductor comprises: a core; a coil wound around the core and having two end portions and a coil portion extending between the end portions; and a green compact made from magnetic powder and enclosing the coil portion of the coil and the core in such a manner that the end portions of the coil are exposed from the green compact.

According to another aspect of this invention, a method for fabricating an inductor, comprises the steps of: disposing a coil and a core in a mold cavity in a mold in such a manner that the core is wound around by the coil; filling the mold cavity with magnetic powder; and compressing the magnetic powder in the mold cavity so as to form a green compact that encloses the core and coil portion.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is an exploded perspective view illustrating a conventional inductor;

FIG. 2 is an assembled schematic sectional view of the conventional inductor shown in FIG. 1;

FIG. 3 is a schematic sectional view illustrating the preferred embodiment of an inductor according to this invention;

FIG. 4 is a fragmentary schematic sectional view illustrating a mold for manufacturing the preferred embodiment of an inductor according to this invention; and

FIGS. 5 to 8 are fragmentary schematic sectional views illustrating consecutive steps of the process for manufacturing the preferred embodiment of an inductor according to this invention.

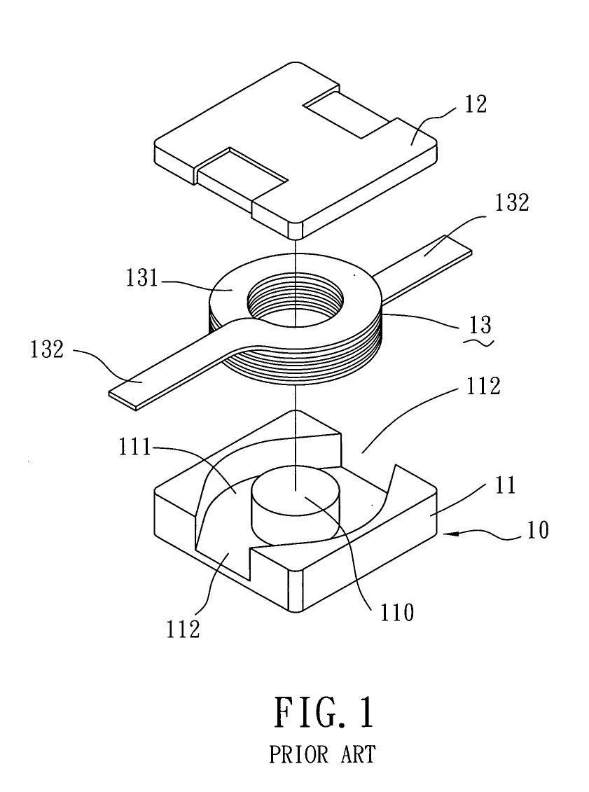

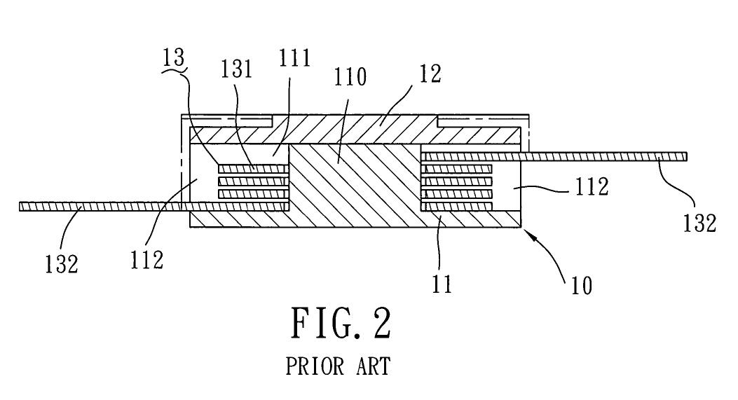

### DETAILED DESCRIPTION OF THE PREFERRED EMBODIMENT

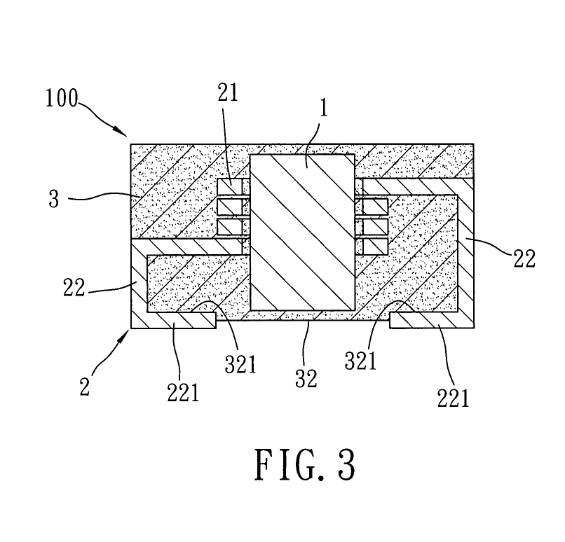

FIG. 3 shows the preferred embodiment of an inductor 100 according to the present invention manufactured via a molding process. The inductor 100 of this invention includes a core 1, a coil 2, and a green compact 3. The coil 2 is wound around the core 1, and has two end portions 221 and a coil portion 21 extending between the end portions 221. The green compact 3 is made from magnetic powder, and encloses the coil portion 21 of the coil 2 and the core 1 in such a manner that the end portions 221 of the coil 2 are exposed from the green compact 3.

Preferably, the core 1 has permeability greater than that of the green compact 3 so as to enhance quality factor of the inductor 100 according to this invention. In this embodiment, the core 1 is made from metal with magnetic properties, and is in the form of a bar piece.

In this embodiment, the coil 2 further has extending portions 22 which connect the coil portion 21 and the end portions 221, respectively. Each of the end portions 221 is bent from the respective one of the extending portions 22. Furthermore, the cross section of the coil 2 varies based on the actual requirements. For example, the cross section of the coil 2 can be circular, rectangular, or flat.

Preferably, the green compact 3 has a bottom end 32 that is formed with two recesses 321. The end portions 221 of the coil 2 are respectively received in the recesses 321 in the green compact 3 in such a manner that the end portions 221 of the coil 2 protrude respectively and outwardly from the recesses 321 in the green compact 3. The inductor thus formed can be mounted on a circuit board (not shown) through surface mount technology (SMT) techniques.

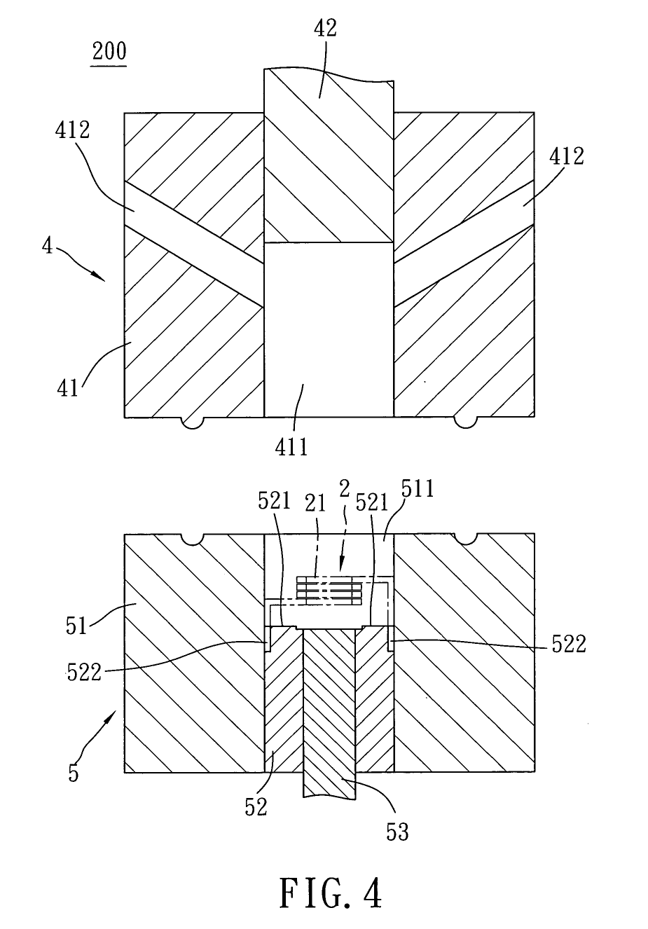

A mold 200 for manufacturing the inductor 100 according to this invention will now be described with additional reference to FIG. 4.

Referring to FIG. 4, the mold 200 for manufacturing the inductor 100 according to this invention defines a mold cavity, and includes an upper mold 4 and a lower mold 5 corresponding to the upper mold 4.

The lower mold 5 includes a lower mold part 51, an insert 52, and an ejector 53 movably inserted into the insert 52. The lower mold part 51 and the insert 52 cooperatively define a lower cavity 511 therebetween. The insert 52 has two concave portions 522 for receiving respectively the two end portions 221 of the coil 2. In particular, the end portions 221 of the coil 2 are respectively inserted into the concave portions 522 of the insert 52 such that the coil portion 21 of the coil 2 is spaced apart from the insert 52. If the mold 200 is used to manufacture an inductor suitable for surface mount technology (SMT), the insert 52 will further have two projecting portions 521, which project from a top surface of the insert 52 for formation of the recesses 321 in the bottom end 32 of the green compact 3.

The upper mold 4 includes an upper mold part 41 corresponding to the lower mold part 51, and a plunger 42. The upper mold part 41 and the plunger 42 cooperatively define an upper cavity 411 corresponding to the lower cavity 511. The upper and lower cavities 411, 511 cooperatively define the mold cavity. The plunger 42 can be moved upwardly and downwardly in the upper and lower cavities 411, 511. The upper mold part 41 further has two runners 412 for passage of molding material into the upper and lower cavities 411, 511.

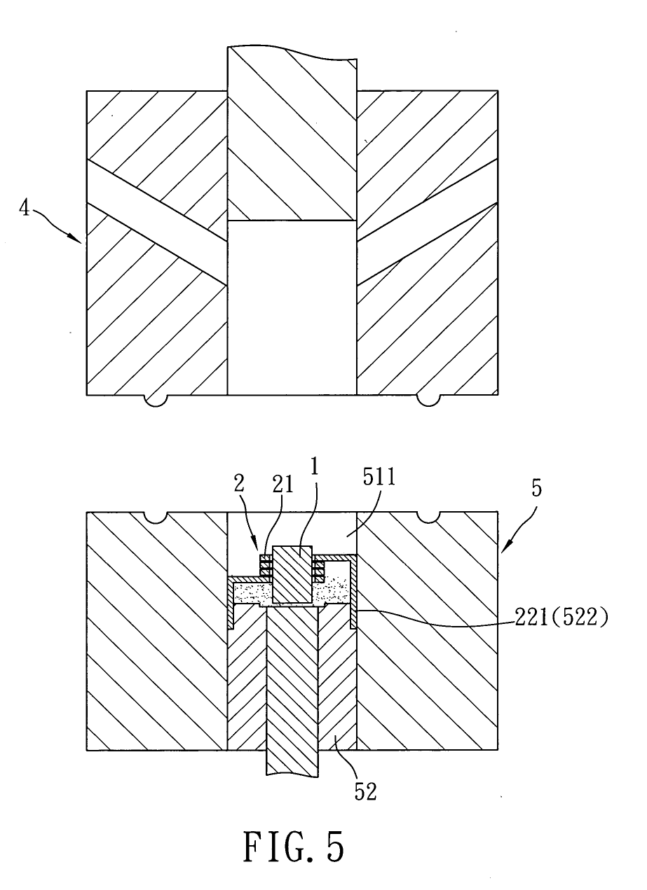

The method for producing the inductor 100 according to this invention using the mold 200 shown in FIG. 4 will now be described in detail with reference to FIGS. 5-8.

As shown in FIG. 5, after the end portions 221 of the inductor 100 are inserted into the concave portions 522 of the insert 52, an amount of magnetic powder is added into the lower cavity 511 in such a manner that the coil portion 21 of the coil 2 is not covered with magnetic powder. Then, the core 1 is inserted into a central space defined by the coil portion 21 of the coil 2. It is noted that, in this step, the upper mold 4 and the lower mold 5 are disposed in an open state.

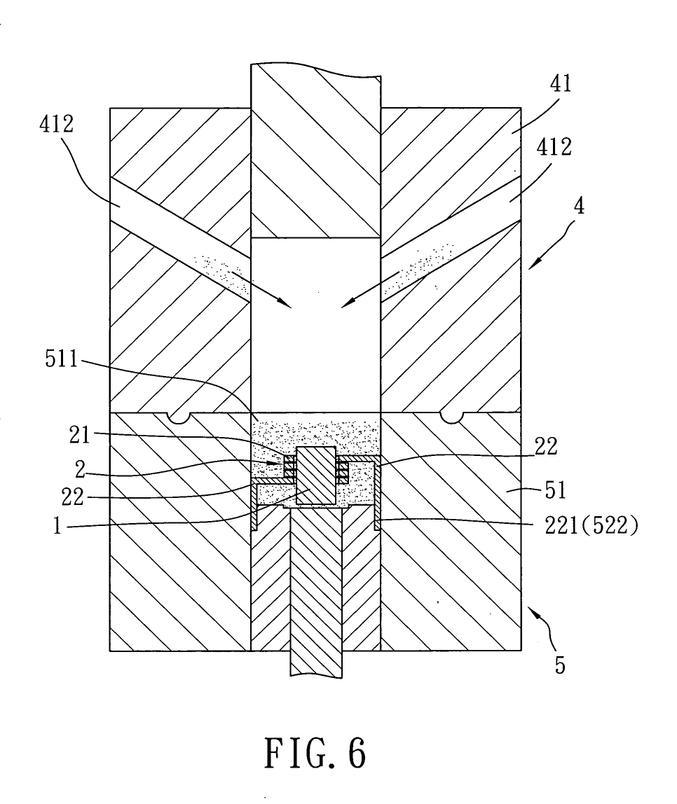

As shown in FIG. 6, the upper mold 4 is moved downwardly toward the lower mold 5 such that the upper mold part 41 and the lower mold part 51 are disposed in a closed state. The remaining amount of the magnetic powder is subsequently directed into the lower cavity 511 through the runners 412 of the upper mold 4 so as to fully cover the core 1 and the coil portion 21 of the coil 2. The end portions 221 of the coil 2, which are respectively inserted into the concave portions 522, are not covered by the magnetic powder.

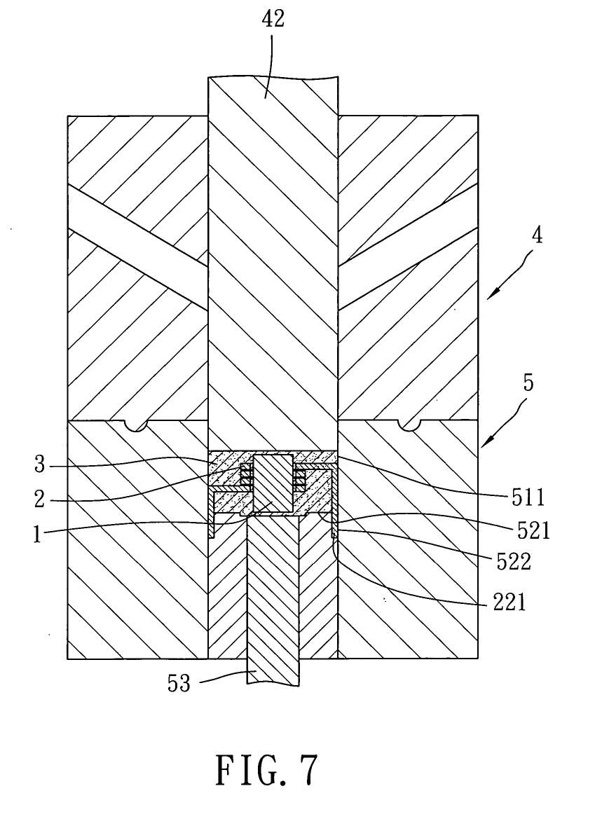

As shown in FIG. 7, the plunger 42 is subsequently moved into the lower cavity 511 to compress the magnetic powder, thereby forming the green compact 3. In the inductor 100 thus formed, except for the end portions 221 of the coil 2, the core 1 and coil 2 are enclosed in the green compact 3.

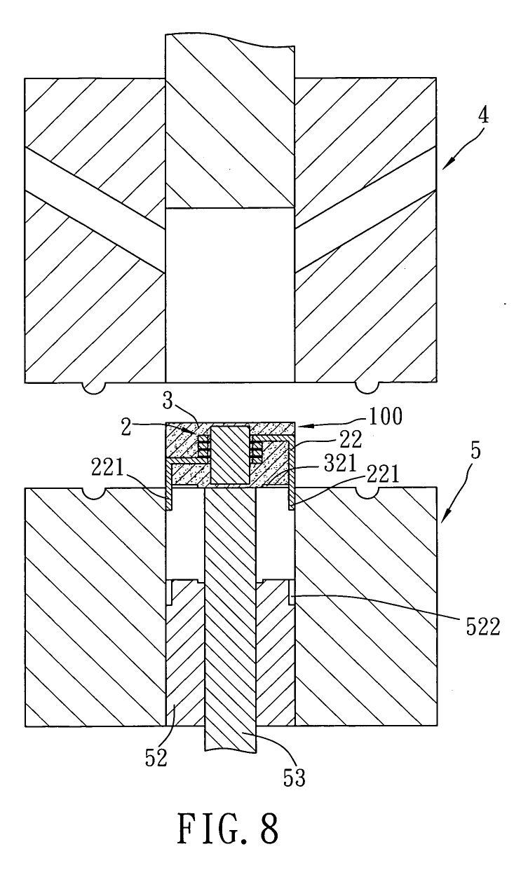

Next, as shown in FIG. 8, after separating the upper and lower molds 4 and 5 from each other, the inductor 100 is removed form the insert 52 of the lower mold 5 by moving upwardly the ejector 53. The inductor 100 thus formed does not have any space or gap therein.

If the inductor 100 is suitable for SMT applications, the end portions 221 of the coil 2 are bent so as to be respectively received in the recesses 321 in the green compact 3, and so as to protrude respectively and outwardly from the recesses 321 in the green compact 3. In other applications, the end portions 221 of the coil 2 need not be bent, and the recesses 321 need not to be formed in the green compact 3.

With the inclusion of the green compact 3 in the inductor 100 of this invention, the aforesaid problems of vibration, noise, core loss, and reduction in quality factor associated with the conventional inductor can be eliminated. In addition, by virtue of the core 1, the problem of deformation of the coil 2 during molding process and the problem of low density at the central space of the coil 2 which caused by uneven distribution of magnetic powder resulting from hindrance of the coil 2 can be avoided. Moreover, it is preferable that the core 1 according to this invention has permeability higher than that of the green compact 3, such that quality factor of the inductor 100 can be further enhanced.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An inductor comprising:
a core;
a coil wound around said core and having two end portions and a coil portion extending between said end portions; and
a green compact made from magnetic powder and enclosing said coil portion of said coil and said core in such a manner that said end portions of said coil are exposed from said green compact.

2. The inductor of claim 1, wherein said core has permeability greater than that of said green compact.

3. The inductor of claim 1, wherein said green compact has a bottom end that is formed with two recesses, said end portions of said coil being respectively received in said recesses in said green compact.

4. The inductor of claim 3, wherein said end portions of said coil protrude respectively and outwardly from said recesses in said green compact.

5. The inductor of claim 1, wherein said core is made from metal with magnetic properties.

6. The inductor of claim 5, wherein said core is in the form of a bar piece.

7. A method for fabricating an inductor, comprising the steps of:
disposing a coil and a core in a mold cavity in a mold in such a manner that the core is wound around by the coil;
filling the mold cavity with magnetic powder; and
compressing the magnetic powder in the mold cavity so as to form a green compact that encloses the core and the coil.

8. The method of claim 7, wherein the core has permeability greater than that of the green compact.
